(19) United States
(12) Patent Application Publication
(10) Pub. No.: US 2006/0054454 A1
(43) Pub. Date: Mar. 16, 2006

(54) Apparatus for currency calculation which can extract serial number and method for the same

(76) Inventor: Jeong-Hwan Oh, Gyeonggi-do (KR)

Correspondence Address: MORGAN & FINNEGAN, L.L.P., 3 WORLD FINANCIAL CENTER, NEW YORK, NY, 10281-2101, US

(21) Appl. No.: 10/525,130

(22) PCT Filed: Jun. 26, 2003
(86) PCT No.: PCT/KR03/01254

§ 371 Date: Feb. 18, 2003

(30) Foreign Application Priority Data
Aug. 19, 2002 (KR) 10 2002 0048844

(51) Int. Cl. G06K 7/00; G07D 7/00; G07F 7/04; G06K 9/00

(52) U.S. Cl. 194/207

(57) ABSTRACT

The present invention relates generally to an apparatus and method for counting currency notes, and more particularly, to an apparatus and method that automatically feed and count a plurality of currency notes, recognize the denominations thereof by reading the images thereof, and extract, store and output the serial numbers thereof. In accordance with the present invention, it is possible to database apparatus-related information, such as the denominations, serial numbers, amounts, serial number region images, and installation locations of continuously fed currency notes, together with processed time information, and to effectively use the currency note counting apparatus in receipt/payment management through the management of the serial numbers of currency notes.

### TECHNICAL FIELD

The present invention relates generally to an apparatus and method for counting currency notes, and more particularly, to an apparatus and method that automatically feed and count a plurality of currency notes, recognize the denominations thereof by reading the images thereof, and extract, store and output the serial numbers thereof.

### BACKGROUND ART

Generally, in order to manage the receipt/payment details of currency notes in financial institutions handling plenty of currency notes, including checks, securities, etc., serial numbers recorded on the currency notes are manually recorded, or there are used apparatuses that are fed with currency notes one by one and recognize the serial numbers thereof, so that a problem arises in that excessive time is required to detect the serial numbers. Furthermore, additional problems arise in that erroneous serial numbers may be recorded in case errors are made in the numerical recognition of serial numbers, and only the serial numbers of specific currencies or denominations can be extracted.

Accordingly, to solve the problems described above, an object of the present invention is to provide an apparatus and method for counting currency notes, which can automatically feed and count a plurality of currency notes, recognize denominations thereof, and extract, store and output the serial numbers thereof.

### DISCLOSURE OF THE INVENTION

The present invention relates generally to an apparatus and method for counting currency notes, which can automatically feed and count a plurality of currency notes, recognize denominations thereof by reading the images thereof, and extract, store and output the serial numbers thereof.

The present invention provides a method of counting currency notes; including steps of feeding a currency note into an apparatus by detecting the currency note placed on a hopper using a hopper sensor and then driving a motor and a clutch, detecting states of the fed currency note and then handling multiple feed/chain feed/jam feed errors based on the detection results, detecting the fed currency note, recognizing denomination of the currency note by scanning the image thereof, and extracting, storing and outputting an image of serial number region of the fed currency note; and incrementing a count when denomination of the currency note has been recognized, and discharging the currency note to a stacker and a reject pocket based on the recognition results.

The method may include the step of outputting the image of the serial number region, together with text data obtained through character recognition of the image data.

The present invention provides an apparatus for counting currency notes, including an automatic feeder unit for feeding a plurality of currency notes placed on a hopper one by one; a drive unit for driving a motor when a hopper sensor detects the plurality of currency notes; a control unit for detecting states of the fed currency notes and handling multiple feed/chain feed/jam errors; a sensor unit for detecting the currency notes and scanning an entire image of the currency notes; a signal processing unit for recognizing denominations of the currency notes from image data of the currency notes input from the sensor unit, extracting serial number regions with respect to each of the recognized denominations, and converting the extracted data into normalized image data of a constant size; a transfer unit for transferring the fed currency notes to an outlet; a selector unit for selectively discharging the currency notes to a stacker and a reject pocket in accordance with process results of the currency notes; and an output unit for outputting stored image data to a printer.

### BRIEF DESCRIPTION OF THE DRAWINGS

FIG. 1 is a diagram showing an internal structure of an apparatus for counting currency notes according to a preferred embodiment of the present invention;

FIG. 2 is a configuration diagram illustrating an operation in which the currency note counting apparatus according to the preferred embodiment of the present invention recognizes currency notes;

FIG. 3 is a block diagram showing a practical embodiment of the currency note counting apparatus according to the preferred embodiment of the present invention;

FIG. 4 is a flowchart showing operations of the main control unit of the currency note counting apparatus according to the preferred embodiment of the present invention;

FIG. 5 is a flowchart showing detailed operations of the signal processing unit of the currency note counting apparatus according to the preferred embodiment of the present invention; and

FIG. 6 is a flowchart showing an output process of the currency note counting apparatus according to the present invention.

### BRIEF DESCRIPTION OF REFERENCE NUMERALS OF PRINCIPAL ELEMENTS

| | |
|---|---|
| 100: hopper | 102: automatic feeder unit |
| 104: transfer unit | 106: contact image sensor |
| 108: drive unit | 110: outward connection unit |
| 112: stacker | 114: selector |
| 116: reject pocket | 118: control panel |

### BEST MODE FOR CARRYING OUT THE INVENTION

Embodiments of the present invention will be described in detail with reference to the attached drawings below.

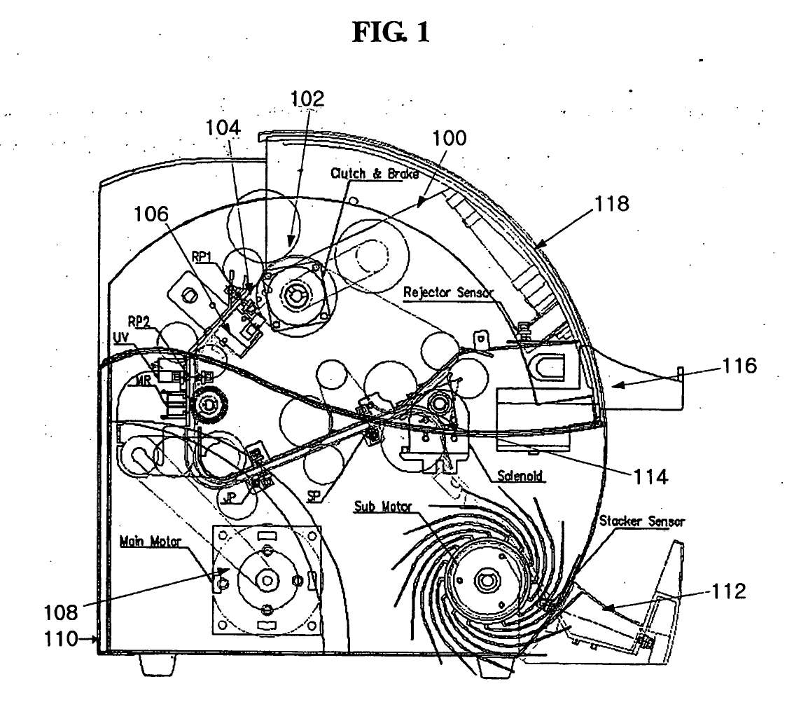

FIG. 1 is a diagram showing an internal structure of an apparatus for counting currency notes according to a preferred embodiment of the present invention.

A hopper 100 is a part on which a plurality of currency notes is placed. When the currency notes placed on the hopper are detected by a hopper sensor, a motor is driven and a clutch is turned on, so that feed rollers are driven, thus putting currency notes into the currency note counting apparatus. An automatic feeder 102 automatically separately feeds the plurality of currency notes placed on the hopper one by one. A transfer unit 104 transfers the fed currency notes to an outlet through a contact image sensor 106 and a magnetic sensor. A selector 114 selects proper outlets according to the process results of a currency note and discharges the currency note therethrough.

As shown in FIG. 1, the currency note counting apparatus includes two outlets, i.e., a stacker 112 and a reject pocket 116. The currency notes, which are inserted with the correct upsides thereof down, have no serial numbers, or are impossible or hard to recognize, are separately discharged into the reject pocket 116. The currency notes discharged into the reject pocket 116 are re-fed with the upsides thereof down, so that both sides thereof can be processed.

A motor drive unit 108 drives the motor when the hopper sensor recognizes the currency notes, and the contact image sensor 106 reads the images of the currency notes in lines and stores them in an internal memory in the form of image data. A control panel 118 manipulates the currency note counting apparatus and displays the process result. An outward connection unit 110 is located on the back of the currency note counting apparatus, and can be connected to an external output device, such as a printer or display, or a Personal Computer (PC).

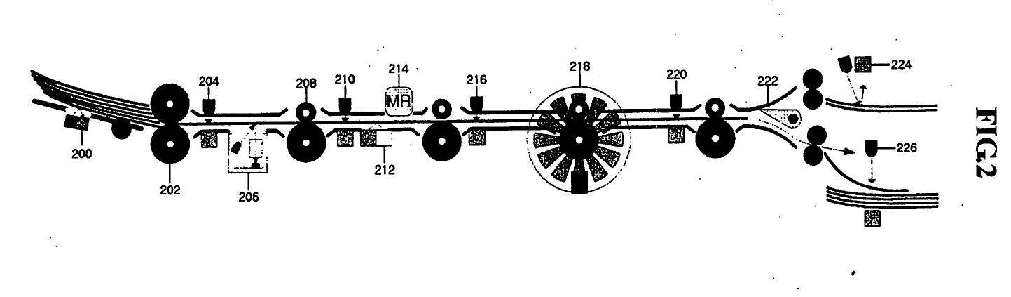

FIG. 2 is a configuration diagram illustrating an operation in which the currency note counting apparatus according to a preferred embodiment of the present invention recognizes currency notes.

As shown in FIG. 2, when a plurality of currency notes fed into the currency note counting apparatus are detected by the hopper sensor 200, a main control unit drives a motor and operates a clutch 202. When currency notes are fed into the currency notes counting apparatus, the currency notes pass through four sensors, i.e., a reading point first sensor 204, a reading point second sensor 210, a jam point sensor 216, and a selector point sensor 220, each of the sensors being composed of two sensors, i.e., right and left sensors. The sensors are arranged so that an interval between two neighboring sensors does not exceeds the width of the currency notes, and are each positioned between two neighboring transferring rollers 208 so as to function to monitor transferred states of the currency notes.

The reading point first sensor 204 detects currency notes to scan the images of the currency notes. The output of the reading point first sensor 204 is connected to both a main control unit 330 and a signal processing unit 350. When the currency notes are detected by a sensor, a contact image sensor 206 is driven to start image scan; when the currency notes pass through the reading point first sensor 204, the operation thereof is stopped after a short period.

Moreover, a multiple feed in which a plurality of currency notes superposed on each other is fed, and a chain feed in which a plurality of currency notes connected to each other are fed are determined using the number of the fed currency notes, and the currency dote fed in an extremely slanted state are determined using the outputs of the left/right sensors of the reading point first sensor. The reading point second sensor 210 detects a currency note and monitors the transferred states thereof, like the reading point first sensor 204.

The jam point sensor 216 monitors the transferred states of currency notes and jams in which the currency notes are jammed inside of the apparatus.

The selector point sensor 220 detects a reference point to drive a swing selector 222. The discharge direction of the currency notes is changed by driving the high-speed swing selector 222 to sort currency notes to a stacker 226 and a reject pocket 224 in accordance with the recognized result of the currency notes or the transferred state of the currency notes. In this case, if the selector point sensor 220 is not accurately driven, it is difficult to smoothly discharge the currency notes, and thus a jam of or damages on the currency notes may occur. The length measurement of the currency notes is performed using the pulse signals of an encoder 218, and the motor controls the pulse output of the encoder 218 to be uniform in order to perform constant-speed drive.

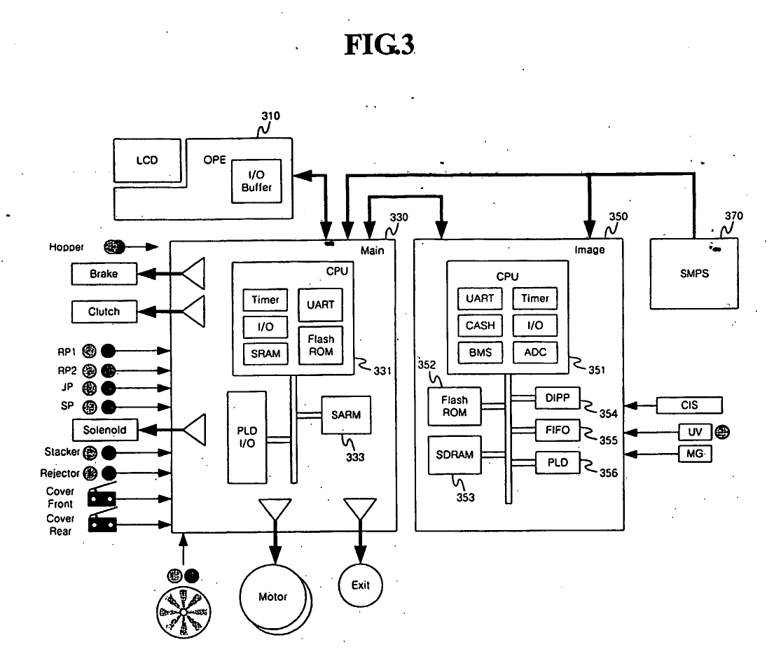

FIG. 3 is a block diagram showing a practical embodiment of the currency note counting apparatus according to a preferred embodiment of the present invention.

As shown in the drawing, the currency note counting apparatus of this embodiment includes an interface unit 310, a main control unit 330, a signal processing unit 350, and a power supply unit 370.

The main control unit 330 operates a drive unit to feed currency notes, and handles multiple feed/chain feed/jam errors by detecting the states of the currency notes. Although not shown in the drawing, in an Electrically Erasable and Programmable Read Only Memory (EEPROM) positioned in a first central processing unit 331, there are stored system options, such as the operation modes of simple counting/mixed counting/one denomination counting, operation speeds, the operation levels of the hopper, currency types, the drive/stop of the apparatus at the time of the occurrence of errors and multiple feed detection, and various states to be reserved in case power is off.

A flash memory, that is, Static Random Access Memory (SRAM) 333, stores temporary data and variables required for the operation of the apparatus, such as the operational status of the sensors, the operational status of the motor, information about the skew of the images of the scanned currency notes, the number of accumulated counted detonations, information about the amounts of money and the time in which the currency notes remain in the sensors, or process results.

When a start signal is input from the main control unit 330 and a currency note is detected by the reading point sensor 1, the signal processing unit 350 scans the image of the fed currency note and recognizes the denomination thereof. An Image Signal PreProcessor (DIPP) 354 receives analog output signals from the contact image sensor, compensates for a distortion phenomenon through a sampling process, converts the analog signals into digital signals, and then transfer image data via a FIFO 355 to memory so as to prevent data loss.

A Flash Read Only Memory (ROM) 352 stores program code, and various items of information, such as system options to be reserved in case power is off, system status, a template to recognize denominations, data to compensate for the distortion of image data.

When power is supplied to an apparatus or the apparatus restarts, the program code stored in the Flash ROM 352 is transferred to Synchronous Dynamic Random Access Memory (SDRAM) 353, and then a program is executed. Scanned image data are preprocessed in the image signal preprocessor 354, and then stored in the SDRAM 353 via the FIFO 355.

In a PLD 356, a data transferring function performed between the main control unit 330 and the signal processing unit 350, a resolution converting function to handle a speed difference between the contact image sensor and the image signal preprocessor 354, a data bus width converting function to handle interface and a data speed difference between a second central processing unit 351 and the image signal preprocessor 354, and the like are implemented.

The signal processing unit 350 can read or store additional items of information, such as the monitoring of the sensor status of the apparatus, the downloading of scanned data, the upgrade of a currency note recognition program, apparatus carrier management, and the like via a PC interface.

A user interface unit 310 transfers the key-inputs of a user to the main control unit 330 and receives Liquid Crystal Display (LCD) output data from the main control unit 330, and includes a graphic LCD that displays key-inputs input by the user, process results and the amount of counted currency notes.

An input to a power supply unit 370 is in the range of 85 to 265V AC, and an output is Direct Current (DC) 3.3V, 5V, −5V, 12V, 24V.

A plurality of currency notes placed on the hopper are separated by the automatic feeder 102. When the currency notes are detected by the hopper sensor, a motor is driven in a drive unit 108 and a currency note is fed into the apparatus.

If no currency note is detected by the reading point first sensor in a certain period after the currency note is fed into an apparatus, this is regarded as the occurrence of a mis-feed, and an error handling process is executed. In contrast, when the currency note is detected, the reading point first sensor detects a multiple feed in which a plurality of currency notes are superposed on each other by checking the number of the fed currency notes. When two or more currency notes overlapped on each other at their front and rear portions are fed, a chain error handling process is executed. When the period in which a currency note pass through the reading point first sensor is longer or shorter than a normal period, a jam error handling process is executed. The length measurement of the currency note is performed based on pulses output from the encoder.

If all the results are normal, the currency note is discharged to the stacker 112 under the control of the selector 114. In contrast, if recognition process results are rejections, the currency note is discharged to the reject pocket 116 under the control of the selector 114. Meanwhile, the main control unit 330 controls the overall currency note counting apparatus, and may perform a simple counting function.

When signals are received from the main control unit 330, the signal processing unit 350 scans the image of the currency note, detects the contours thereof, calculates information about the positios and skes of the currency nots, and compensates for the skew and geometrical distortion of image data by geometrically correcting and preprocessing the mage data. If it is determined that the top and bottom of image data are reversed, the top and bottom of the image data are caused to be reversed. When it is determined that the inserted direction of the image data is normal, the denomination of the currency note is recognized using a pattern recognizing method employing template matching.

Recognition result for the currency note is transferred to the main control unit 330, and the currency note is separately discharged to the stacker or the reject pocket. For currency note whose denomination is recognized, serial number region is set using previously known serial number position information and are extracted according to the denomination.

The signal processing unit 350 converts the partial image data of the extracted serial number region into the normalized image data of constant size, and then into binary data capable of being outputted. The converted binary image data can be converted into character or numeral data through character recognition. The converted binary image data can be output to the external output device, or can be stored in the internal or external storage device of the currency note counting apparatus and be output to an output device, such as a printer, if necessary.

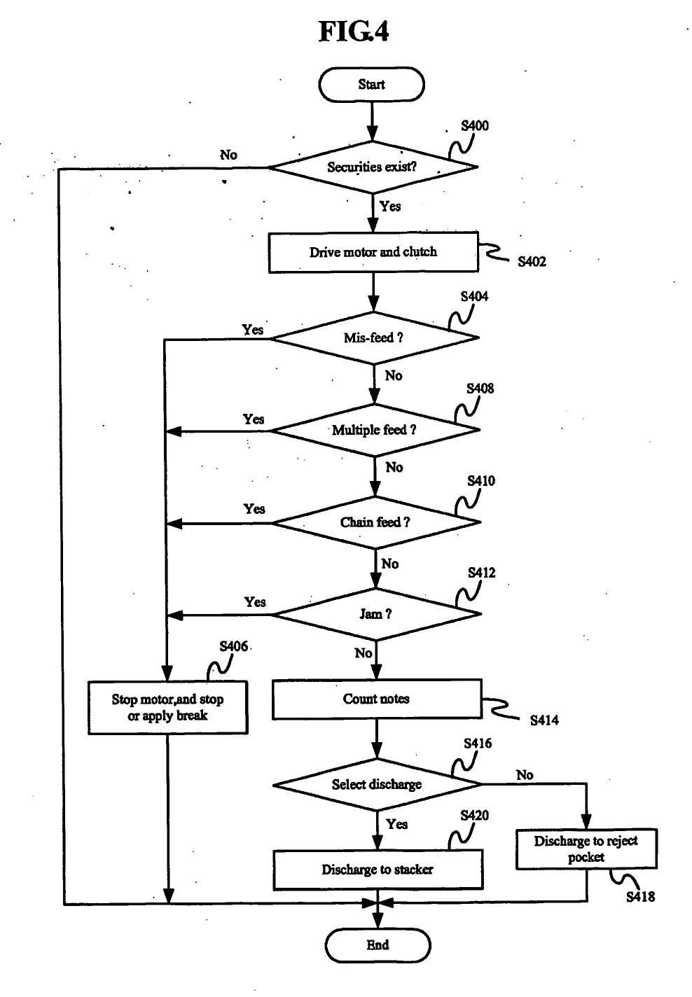

FIG. 4 is a flowchart showing operations of a main control unit of the currency note counting apparatus according to a preferred embodiment of the present invention.

First, if currency notes placed on the hopper are detected by the hopper sensor at step S400, the motor and the clutch are turned on, so that the feed rollers are driven, thus putting the currency notes into the apparatus at step S402. If the currency notes placed on a hopper are not detected, the apparatus does not operate. If any currency note is not detected by the reading point first sensor in a certain period after the clutch has started, this is regarded as the occurrence of a mis-feed, and an error handling process is executed at step S404. The reading point first sensor detects a multiple feed in which a plurality of currency notes superposed on each other are fed by checking the amount of the fed currency notes at step S408. If two or more currency notes overlapped at the front and rear portions thereof and connected to each other are fed, a chain error handling process is executed at step S410. If the period in which a currency note passes through the reading point first sensor is longer or shorter than a certain period, a jam error handling process is executed at step S412. If there is a mis-feed, a multiple feed, a chain feed in which a plurality of currency notes connected to each other are fed, and a jam in which currency notes are inserted into the apparatus, the motor and the clutch stop at step S406. If the above results are normal, the number of the fed currency notes are counted at step S414, discharge is selected under the control of the swing selector at step S416, and the currency notes are discharged to the stacker at step S420. If currency note recognition result is rejection, the currency note is discharged to the reject pocket at step S418.

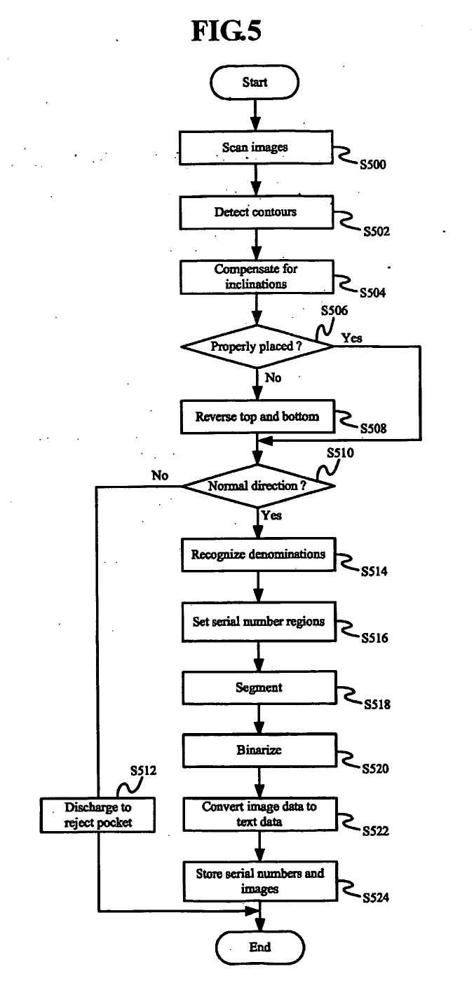

FIG. 5 is a flowchart showing detailed operations of the signal processing unit of the currency note counting apparatus according to the preferred embodiment of the present invention.

First, a plurality of currency notes detected by the hopper sensor are separated from each other and are fed to the apparatus one by one by the automatic feeder unit. The currency note fed to the apparatus is read in lines by the contact image sensor and are stored in the internal memory in the form of image data at step S500. The contours of the currency note are found from the image data stored in the internal memory using a contour detecting method, and the position, skew and size of the currency note are calculated from the contour information of the currency note at step S502. In accordance with the above results, skew or geometrical distortion is compensated for by geometrically correcting and preprocessing the image data at step S504. It is determined whether the image data are properly placed, and if it is determined that the image data are upside down at step S506, the top and bottom of the image data are reversed at step S508.

As a result, the inserted direction of the image data placed properly is checked at step S510. If the currency note has been inserted in a normal direction, the denomination thereof is recognized using a pattern recognizing method employing template matching at step S514. If the currency note has been inserted in a reverse direction, has no serial number or if it is impossible or hard to recognize it, the currency note is separately discharged into the reject pocket at step S512. For currency notes whose denominations are recognized, serial number regions are set at step S516 and are extracted according to the denominations thereof using previously known serial number position information at step S518. The partial image data of the extracted serial number regions are converted into the normalized image data of a constant size. In addition, the image data can be converted into binary data capable of being output to a printer at step S520. Further, the image data can be converted into text data through character recognition at step S522. The text data and the image data are stored in the internal or external storage device at step S524. Further, the stored text data or image data can be output to the printer.

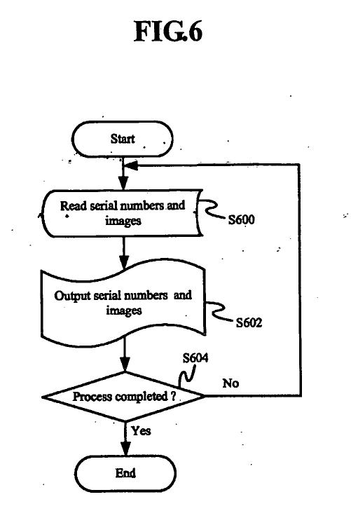

FIG. 6 is a flowchart showing an output process of the currency note counting apparatus according to the present invention.

When the user pushes an output button to output the serial numbers and images of currency notes, the serial numbers and images of the currency notes, which are stored in the internal or external storage device of the currency notes counting apparatus, are read at step S600 and the serial numbers and images of the currency notes are all output to the printer or similar output devices at step S602. If an automatic printing mode is set, the processing of a plurality of currencies is completed by a hopper, and it is possible to automatically output count results to the print at step S604.

Accordingly, the present invention is advantageous in that the recording of the serial numbers of currency notes, which is manually performed in a conventional scheme, is processed together with the recognition of the denominations of the currency notes, thus being operated at high speeds compared with a one-by-one insertion method, a plurality of currency notes are automatically fed and counted, and recognized denominations and serial numbers of the currency notes can be stored or output.

Although the example in which the main control unit and the signal processing unit are separately configured has been described above, it is possible to implement them as a single processor.

In addition, although, in the above example, the proper placements of the currency notes are judged and the denominations of the currency notes are recognized after compensations are made for the skews of the currency notes, it is possible to compensate for only the skews of serial number regions after recognizing the denominations and judging the proper placements.

As described above, the present invention is not limited to a specific embodiment, and those skilled in the art will appreciate that various modifications, additions and substitutions are possible, without departing from the scope and spirit of the invention.

### INDUSTRIAL APPLICABILITY

As described above, in accordance with the present invention, it is possible to database apparatus-related information, such as the denominations, serial numbers, amounts, serial number region images, and installation locations of continuously fed currency notes, together with processed time information, and to effectively use the currency note counting apparatus in receipt/payment management through the management of the serial numbers of currency notes.

1. A method of counting currency notes, comprising:
step 1 of feeding a currency note into apparatus by detecting the currency note placed on a hopper using a hopper sensor and then driving a motor and a clutch;
step 2 of detecting states of the fed currency note and then handling multiple feed/chain feed/jam feed errors based on the detection results;
step 3 of detecting the fed currency note, recognizing denomination of the currency note by scanning the image thereof, and extracting, storing and outputting an image of serial number region of the fed currency note; and
step 4 of incrementing a count when denomination of the currency note has been recognized, and discharging the currency note to a stacker and a reject pocket based on the recognition results.

2. The method as set forth in claim 1, wherein the step 3 comprises:
step 3-1 of scanning the currency note in lines and storing the scanned images in an internal memory in an image data form;
step 3-2 of finding contours of the currency note from the image data stored in the internal memory;
step 3-3 of compensating for skew or geometrical distortion of the image data by geometrically correcting and preprocessing the image data;
step 3-4 of recognizing denomination of the currency note from the compensated image data using a pattern recognizing method employing template matching in accordance with the inserted direction of the currency note;
step 3-5 of setting serial number region and extracting the image of the serial number region for the currency note whose denomination have been recognized using previously known serial number position information with respect to the recognized denomination;
step 3-6 of converting the extracted image data into normalized image data of a certain size; and
step 3-7 of storing and outputting the image data.

3. The method as set forth in claim 1, wherein, in the step 3, the image of the serial number region is output, together with text data obtained through character recognition of the image data.

4. The method as set forth in claim 2, further comprising the step of correcting the compensated image data when top and bottom of the currency note is reversed, between step 3-3 and step 3-4.

5. The method as set forth in claim 4, further comprising the step of converting the normalized image data into binary data between step 3-6 and step 3-7, wherein, in step 3-8, the binary data are stored and output.

6. An apparatus for counting currency notes, comprising:
an automatic feeder unit for feeding a plurality of currency notes placed on a hopper one by one;
a drive unit for driving a motor when a hopper sensor detects the plurality of currency notes;
a control unit for detecting states of the fed currency notes and handling multiple feed/chain feed/jam errors;
a sensor unit for detecting the currency notes and scanning an entire image of the currency notes;
a signal processing unit for recognizing denominations of the currency notes from image data of the currency notes input from the sensor unit, extracting serial number regions with respect to each of the recognized denominations, and converting the extracted data into normalized image data of a constant size;
a transfer unit for transferring the fed currency notes to an outlet;
a selector unit for selectively discharging the currency notes to a stacker and a reject pocket in accordance with process results of the currency notes; and
an output unit for outputting stored image data to a printer.

7. The apparatus as set forth in claim 6, wherein the signal processing unit outputs text data obtained through character recognition of the stored image data, together with the stored image data, through the output unit.

8. The apparatus as set forth in claim 6, wherein the signal processing unit finds contours of the image data of the currency notes input from the sensor unit, compensates skew or geometrical distortion of the currency notes by calculating information about skews of the currency notes, checks inserted directions of the currency notes, and recognizes denominations of the currency notes using a pattern recognizing method employing template matching.

9. The apparatus as set forth in claim 6, wherein the signal processing causes the compensated image data to be upside down when a top and a bottom thereof are reversed.

10. The apparatus as set forth in claim 6, wherein the signal processing unit converts the normalized image data into binary data and stores the binary data.
